(19) United States
(12) Patent Application Publication
(10) Pub. No.: US 2009/0315891 A1
(43) Pub. Date: Dec. 24, 2009

(54) METHOD AND SYSTEM FOR AUTOMATIC RANGE DETERMINATION OF DATA FOR DISPLAY

(75) Inventors: Michael Lesser, Melbourne, FL (US); Michael Workman, Melbourne, FL (US); Kerry Gilger, Indialantic, FL (US); C. Daniel Repik, Palm Bay, FL (US); Mike Gilger, Satellite Beach, FL (US)

Correspondence Address: FYI CORPORATION;c/o DR. MICHAEL ESSER, 405 ATLANTIC STREET, MELBOURNE BEACH, FL, 32951, US

(73) Assignee: FYI Corporation, Melbourne, FL (US)

(21) Appl. No.: 12/141,660

(22) Filed: Jun. 18, 2008

(51) Int. Cl. G06T 11/20

(52) U.S. Cl. 345/440

(57) ABSTRACT

A system and method for automatically determining state ranges for data displayed on a display medium is disclosed. At least one metric relating to an object within a problem set is selected. Range parameters used in generating state ranges for each selected metric are specified. The range parameters include the number of state ranges for each metric and at least one statistical model. Data reflecting the values of each selected metric is input and analyzed using the range parameters, resulting in at least one state range for each of the selected metrics and statistical models. The statistical model that provides the best fit to the data is selected. The state ranges for the selected metrics and statistical model are output for use by a display medium that displays data relating to the selected metrics as a graphical representation of a state of the object to which the metric relates.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for automatically determining ranges for data to be displayed on a display medium, and more particularly to systems and methods for automatically determining ranges relating to states displayed by knowledge enhanced graphical symbols.

### BACKGROUND OF THE INVENTION

Various devices and methodologies are used to display data to end users. For example, data may be displayed on a graphical user interface, a report, or a video presentation. The types of data displayed may include, for example, that relating to aspects of a business enterprise, a manufacturing process, or an apparatus. Graphic or symbolic representations of the values of the data are an effective way to display data to an end user.

One particularly effective way to represent data graphically is through the use of knowledge enhanced graphical symbols, as taught in commonly-owned U.S. Pat. No. 5,321,800 issued Jun. 14, 1994 and U.S. patent application Ser. No. 11/367,789 Entitled “Expanded Graphical Interface For Information Cognition” filed Mar. 3, 2006, both of which are incorporated herein by reference. Knowledge enhanced graphical symbols typically display the values of data as a symbolic representation of one or more states which represent an interpretation of the significance of the values of the data. In one simple example, a display unit displays as red if a value is below an expected value, blue if the value matches an expected value, and green if the value is above an expected value. In addition to color, such states may also be represented any other graphic technique supported by the display medium, for example, as a pattern, an animation, or a combination of such techniques.

The states represented by a knowledge enhanced graphical symbol may be defined as a set of ranges of values the underlying data can assume. The ranges may represent a simple or complex interpretation of the data. A typical interpretation of data is the extent to which the data deviates from a standard or mean. States may represent a simple, uniform percentage deviation from the mean, or a complex statistical analysis, depending on the pattern the values found in the data. One method for setting range definitions for specific knowledge enhanced graphical symbols used in a graphical user interface is to define the range manually for each symbol. Determining how such ranges should be defined may, however, prove very problematic if there may be no statistical frame of reference to determine the ranges.

Ideally, organizations establish benchmarks using statistical methods and best practices that lead to meaningful benchmarks, but such benchmarks may not be available. Hence, users may arbitrarily establish initial benchmarks for data. Expectation based knowledge enhanced graphical symbols may be very effective for displaying the state of one or more metrics e.g. a specified level of performance relative to a stated policy or benchmark. However, when benchmarks are arbitrarily defined, then the knowledge enhanced graphical symbols could incorrectly switch states, thus incorrectly indicating actions that need to be taken.

### SUMMARY OF THE INVENTION

In one embodiment, the invention provides a method and computer readable medium for automatically determining state ranges for data displayed on a display medium. At least one metric relating to an object within a problem set is selected. Range parameters used in generating state ranges for each selected metric are specified. The range parameters include the number of state ranges for each metric and at least one statistical model. Data reflecting the values of each selected metric is input and analyzed using the range parameters, resulting in at least one state range for each of the selected metrics and statistical models. The statistical model that provides the best fit to the data is selected. The state ranges for the selected metrics and statistical model are output for use by a display medium that displays data relating to the selected metrics as a graphical representation of a state of the object to which the metric relates. Each of the steps in the method are performed by at least one computer.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a flowchart illustrating one embodiment of a process 1000 for automatically determining ranges for metrics which are displayed by a user interface using knowledge enhanced graphical symbols.

FIG. 2 illustrates one embodiment of a physical system capable of supporting at least one embodiment of the process 1000 illustrated in FIG. 1.

FIG. 3 illustrates one embodiment of the modules comprising a server capable of supporting at least one embodiment of the process illustrated in FIG. 1.

FIG. 4 illustrates one embodiment of a sigmoid curve.

FIG. 5 illustrates one embodiment of a double sigmoid curve.

### DETAILED DESCRIPTION

The present invention is described below with reference to block diagrams and operational illustrations of methods and devices to store and/or access streaming media. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” should be understood to refer to a user of a graphical user interface which display metrics relating to one or more objects within a problem set. By way of example, and not limitation, the term “end user” can refer to a person who is uses a graphical user interface that displays knowledge enhanced graphical symbols to evaluate the state of one or more object within a business organization.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other medium which can be used to store the desired information and which can be accessed by the computer.

For the purposes of this disclosure a module is a software, hardware, or firmware (or combinations thereof system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers.

For the purposes of this disclosure the term “metric” is a property of an object which can be stated in quantitative form. Metrics have values that may vary from object to object and that may vary over time. A set of values for a metric may be stored as data on a computer readable medium. By way of example, and not limitation, the term “metric” can refer to a property of an object within a business organization, such as monthly sales (i.e., varying over time) for every location within a region (varying from object to object). A given object may possess multiple metrics. A given metric may represent a combination of properties of an object, for example, net profits may reflect sales less expenses.

Reference will now be made in detail to illustrative embodiments of the present invention, examples of which are shown in the accompanying drawings.

The embodiments discussed below generally relate to methods and systems for automatically determining ranges for metrics which are displayed by knowledge enhanced graphical symbols in a graphical format that represents one or more states such metrics may assume. In one embodiment, a set of ranges for a knowledge enhanced graphical symbol are a set of value pairs that define one or more states of a metric represented by a graphical symbol on a display, for example, a graphical user interface.

The number of states which are defined is a design decision. A greater number of states provides more granularity and may reflect subtle distinctions between the states of a metric, whereas a smaller number of states may be more easily recognized by an end user. In practice, use 7 to 9 different states often provides effective presentation of the state of a metric, although a smaller or greater number is possible. In a graphic display, when a data source sends a new value for a metric being monitored by a knowledge enhanced graphical symbol, the graphic symbol maps this new value to one of a set value pairs to determine which state to display.

In one embodiment, the process of defining the ranges associated with states displayed by knowledge enhanced graphical symbols is provided by an automated, statistical analysis of the data that determines the states displayed by the graphical symbol. For example, consider a measure of rainfall. If the measure of rainfall was 10 inches, it may not be known where the measure was taken, or what the expected rainfall should be. A knowledge enhanced graphical symbol which incorporates built-in benchmarks using ranges which define states which indicate to what extent the metric deviates from expected rainfall is more informative. Such ranges may be determined, for example, by an automated time-based analysis of the data underlying the metric that that statistically determines the baseline for the metric as well as quantify deviations from baseline readings.

In most cases, the larger the sample set of data that is analyzed, the more accurate and meaningful the resulting range definitions will be. However, some of the methods defined below may be effective even with small samplings of source data.

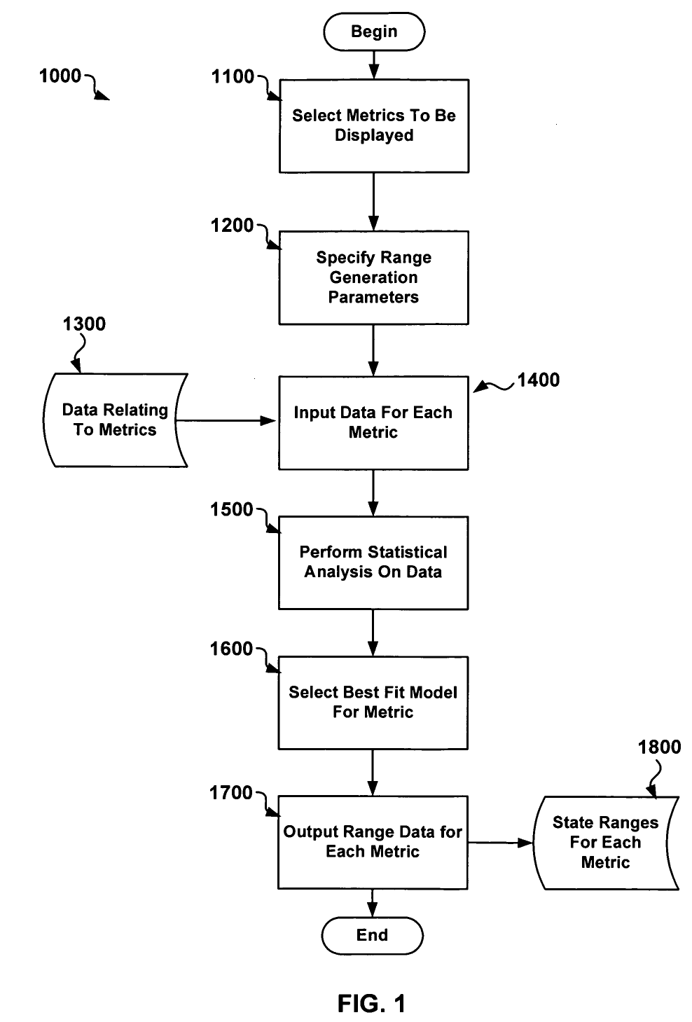

FIG. 1 is a flowchart illustrating one embodiment of a process 1000 for automatically determining ranges for metrics which are displayed by a user interface using knowledge enhanced graphical symbols. Initially, one or more metrics are which are to be displayed, for example, on a user interface that supports knowledge enhanced graphic symbols, are selected 1100. In one embodiment, a user selects one or more metrics using a user interface. In another embodiment, all metrics which relate to objects within a problem set are automatically selected by the system. For example, all metrics relating to purchase orders for delivery to a distribution center may be automatically selected. In another embodiment, metrics are selected by another software system which is operatively connected to the process 1000.

For every metric selected, range generation parameters are specified 1200. In one embodiment, range generation parameters comprise the number of state ranges to be generated for each metric and one or statistical models to be used in creating the ranges. In one embodiment, a user range generation parameters are specified using a user interface. In another embodiment, range generation parameters are automatically selected. For example, the system may use system defaults for the number of state ranges and the statistical model to use. In another embodiment, range generation parameters are selected by another software system which is operatively connected to the process 1000.

The statistical model selected in step 1200 may be any statistical model capable of being used to divide a set of data points into two or more meaningful sets bounded by non-overlapping ranges. For example, in one embodiment, data points may be divided into sets by percentage deviation from the mean of the data points. For example, data may be divided into three sets where one set represents data points whose value is more than 30% below the mean of all data points, a second set representing data points whose value is between 30% below the mean and 30% above the mean of all data points, and a third set representing data points whose value is more than 30% above the mean of all data points.

In another embodiment, data points may be divided into sets by standard deviations from the mean of the data points. For example, data may be divided into three sets where one set represents data points whose value is more than one standard deviation below the mean of all data points, a second set representing data points whose value is between one standard deviation below the mean and one standard deviation above the mean of all data points, and a third set representing data points whose value is more than one standard deviation above the mean of all data points.

In other embodiments, step 1200 may utilize linear regression, nonlinear and logistic regression, or k-means analysis techniques as discussed in more detail below. It will be readily apparent to those skilled in the art that other statistical models and techniques may be used to divide data points into two or sets bounded by non-overlapping ranges.

In one embodiment, the algorithms utilized by the various statistical techniques are modifiable based on user input. Such user input may be supplied, for example, using configuration files, shared communication tables, or a pre-defined API that allows an external system to interrogate the algorithm to obtain descriptions of properties of an algorithm that the user is allowed to change. The descriptions may be used to allow a GUI to construct a dialog that allows the user to make a modification that will adjust how the algorithm is applied to data.

In one embodiment, the GUI displays text, such as a description of how an algorithm can be modified, and an edit field that allows a basic value to be changed, such as, for example, the “K” value. In another embodiment, the GUI is more complex and displays a list of the states, and allows the modification of weighting factors for each of the states, or allows entry of multiple weighting factors that drive how the grouping or heuristics are computed. In another embodiment, the range computed by the system is also passed to the GUI for display to the user.

In step 1400, data containing the values of the selected metrics and values of any other metrics which are necessary to perform the requested statistical analysis are input from one or more data sources 1300. In one embodiment, the data source 1300 is one or more databases or files stored on a computer readable medium on a server. In another embodiment, the data source is a computer based system residing on a server. In another embodiment, the data source is manual input. The data source 1300 may reside on a server supporting the input data process 1400, may reside on another server within the same organization, or may reside on a third party server.

In step 1500, the input data stream is statistically analyzed using the selected range generation parameters and the specified number of state ranges are generated, each range comprising at least one data pair specifying the upper and lower bounds of the range. Where more that one statistical model is evaluated for a given metric, the model which is the best fit for the metric is selected 1600. In one embodiment, the best fit model is automatically selected by the system, for example, the best least squares fit for two or more linear regression models may be automatically selected. In one embodiment, the best fit model is automatically selected by the system, for example, the best least squares fit for two or more linear regression models is automatically selected. In another embodiment, all models analyzed and the results of the analysis are displayed on a user interface and an end user selects a model.

In one embodiment, the method and system utilizes “machine learning” to mine the data stream to determine how to map discrete data points into specific ranges. Methods for analyzing and modeling data can be divided into two groups: supervised learning and unsupervised learning. Supervised learning requires input data that has both predictor (independent) variables and a target (dependent) variable whose value is to be estimated. By various means, the process learns how to model (predict) the value of the target variable based on the predictor variables. Such an approach may be particularly useful where a end user is interested in predicting or characterizing the behavior of a specific metric within a problem set.

Unsupervised learning, by contrast, does not identify a target (dependent) variable, but rather treats all of the variables equally. In such a case, the goal is not to predict the value of a variable but rather to look for patterns, groupings or other ways to characterize the data that may lead to understanding the way the data interrelates. It is this leaning approach that may be used to classify input data into appropriate groupings that map to specific ranges. Such an approach may be particularly useful where a end user does not fully understand the relationships of various metrics within a problem set.

In step 1700, the generated ranges are output. In one embodiment, the generated ranges are output to a computer readable medium 1800. The ranges may be used by a display process to group data relating to a metric into one of a group of states. The state of a data point may then be used to graphically display the state of the data point on a display medium.

In one embodiment, the ranges are input to a system implementing a graphical user interface which uses knowledge enhanced graphical symbols to display the state of one or more metrics. A range may relate to one or more knowledge enhanced graphical symbols. When the value of a metric falls within a specific state, the knowledge enhanced graphical symbol the metric relates to exhibits display characteristics associated with that state. For example, a metric whose value is below average may be associated with the color red, a metric whose value is average may be associated with the color green, and a metric whose value is above average may be associated with the color blue.

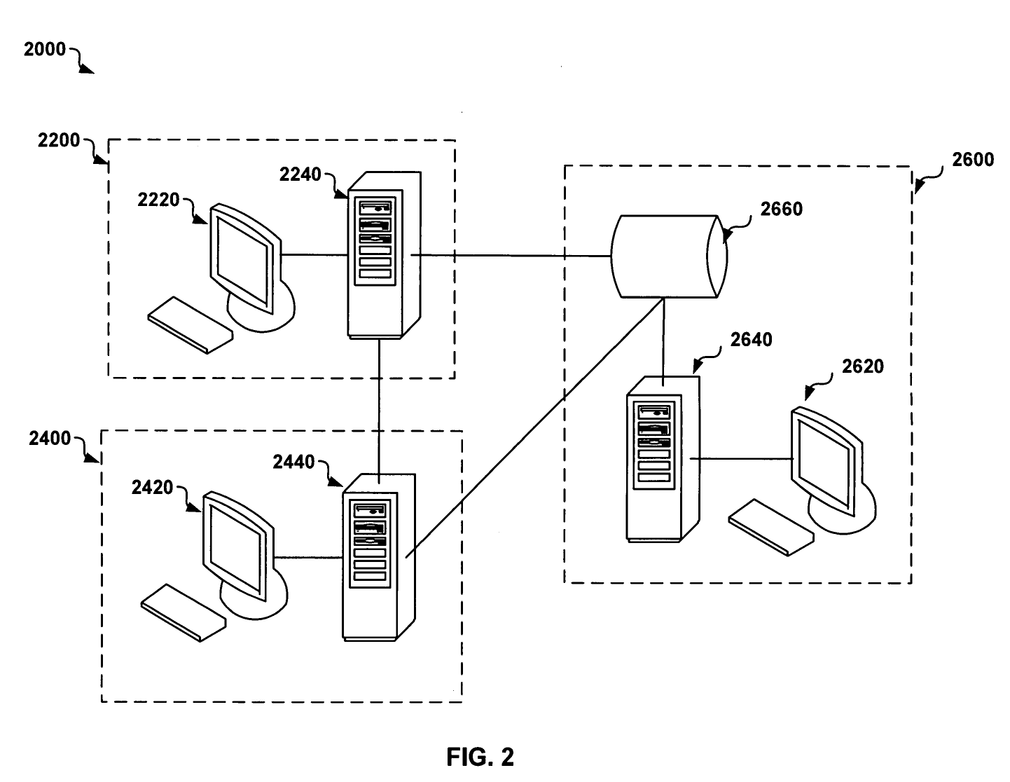

FIG. 2 illustrates one embodiment of a physical system capable of supporting at least one embodiment of the process 1000 illustrated in FIG. 1. The process steps 1100-1700 are implemented on an automatic range determination server 2240 located at a server location 2200 which, in one embodiment, is within the infrastructure of the organization which is also the consumer of generated range data. The server 2240 may be a dedicated server for the range generation process, or may additionally host unrelated systems and services. The server has a display device 2220 which may be used to initiate and control the process 1000 and input selections and parameters to the process as needed.

In one embodiment, the data relating to metrics (1300 of FIG. 1) resides on a physical data storage device 2660 and the server 2240 retrieves data for metrics directly from storage device 2660. In another embodiment, the server retrieves data through a server 2640 connected to data store 2660 using the server's 2640 system services or application systems residing on the server 2640. The server 2240 processes the data according to the process 1000 described above and generates state ranges for selected metrics.

In one embodiment, the state ranges (1800 of FIG. 1) are output to a end user server 2440 at a server location 2400 that implements a graphical user interface that displays the data relating to metrics residing on the data storage device 2660 using knowledge enhanced graphical symbols on a display device 2420. The application framework that implements the graphical user interface on server 2440 uses the state ranges to set display states for each knowledge enhanced graphical symbol displayed by the user interface. The application framework that implements the graphical user interface on server 2440 may then obtain metrics data residing on the physical data storage device 2660 directly or though the services of the server 2640.

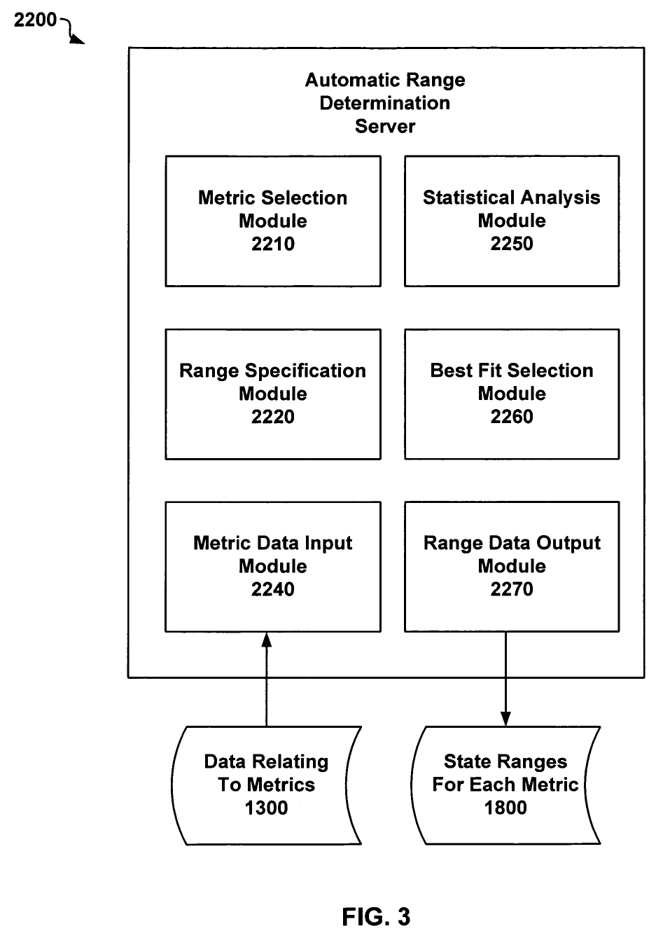

FIG. 3 illustrates one embodiment of the modules comprising a server 2440 capable of supporting at least one embodiment of the process 1000 illustrated in FIG. 1. The server comprises a metric data selection module 2210 that selects at least one metric to analyze, wherein the metric relates to at least one property of an object within a problem set, for example a metric relating to the financial performance of one location of a business entity. In one embodiment, the metric selection module 2210 enables an end user to select metrics using a graphical user interface. In another embodiment, the metrics are selected automatically by the metric selection module 2210 using selection criteria supplied by a system operating on a server, for example, default values supplied by an end user, or selection criteria generated by a third party software application.

The server further comprises a range specification module 2220 that specifies range parameters to be used in generating state ranges for each selected metric. The range parameters comprise the number of state ranges to be generated for each metric and at least one statistical model to be used in creating the state ranges for each metric. For example, for a given metric, three states may be specified, and three statistical models, each comprising different linear regression analyses, may be specified. In one embodiment, range specification module 2220 enables an end user to select range parameters using a graphical user interface. In another embodiment, the range parameters are selected automatically by the range specification module 2220 using range parameters supplied by a system operating on a server, for example, default values supplied by an end user, or selection criteria generated by a third party software application.

In one embodiment, he range specification module enables an end user to modify at least one property of selected statistical model using a graphical user interface, configuration files, shared communication tables, or a pre-defined API usable by external systems. The graphical user interface may additionally or alternatively display a list of a states, and allows the modification of weighting factors for each of the list of states, or allows entry or multiple weighting factors that determine how grouping or heuristics are computed.

The server further comprises a metric data input module 2240 which inputs data reflecting the values of each selected metric and values of any other metrics which are necessary to perform the requested statistical analysis from at least one data source. In one embodiment, the data source is a computer readable medium residing on a data storage device 1300. In another embodiment, the data source is a server, for example, a third party software application residing on a server which provides an API through which data may be retrieved.

The server further comprises a statistical analysis module 2250 that analyzes the input data for each of the selected metrics using the range parameters. The results of the analysis comprise at least one state range for each of the selected metrics and each of the selected statistical models.

The server further comprises a best fit selection module 2260 that selects one of the statistical models for each of the selected metrics that provides the best fit to the data. For example, in the case of three linear regression models, the model providing the best least-squares fit is selected. In one embodiment, the best fit selection module 2260 enables an end user to select the model using a graphical user interface. In another embodiment, the best fit selection module enables a system operating on a server to select the statistical model providing the best fit to the data for example, a third party software application.

The server further comprises a range data output module 2270 that outputs the state ranges for each of the selected metrics and selected statistical models, where the state ranges are used by a display medium to display data for at least one of the selected metrics as a graphical representation of a state of the object to which the metric relates. In one embodiment, the range data output module 2270 outputs the state ranges for each of the selected metrics and selected statistical models to a computer readable medium. In one embodiment, the display medium is a graphical user interface which displays the data for the selected metrics using knowledge enhanced graphical symbols.

This disclosure will now discuss in greater how the present system and method may use several sophisticated statistical analysis techniques to automatically generate ranges for display of metrics on a display medium. Nothing in this disclosure, however, should be taken to limit the method and system disclosed herein to the statistical models and techniques discussed herein.

Linear and Non-Linear Regression

One of the simplest and most popular modeling methods that can be utilized for machine learning is linear regression. Linear regression models the relationship between a dependent variable y and independent variables xi, where i=1, . . . , n. In its simplest embodiment, the form of the function fitted by linear regression is:

y=a₀+a₁*x₁+a₂*x₂+ . . . aₙ*xₙ

The values of the parameters aᵢ are determined so the function best fits the data. As will be appreciated by those skilled in the art, linear regression models may be fit to data using any well know analysis technique such as, without limitation, least-squares analysis, polynomial fitting, or robust regression

As will be appreciated by those skilled in the art, linear regression models may encompass polynomial equations as well, for example:

y=a₀+a₁*x₁+a₂*x₂+ . . .

This model is said to be linear because the relation of the dependent variable y to the independent variables is assumed to be a linear function of the parameters, even though the graph on x by itself is not a straight line. In other words, y can be considered a linear function of the parameters, even though it is not a linear function of one or more of the variables.

A linear regression model may be used to predict the value of a single metric given values of all other dependant metrics. In one embodiment, for example, the predicted value may then be used to define a three state range set, a first range that is below prediction, a second range that meets prediction, and a third range that exceeds prediction. For example, the Capital Asset Pricing Model (CAPM) may be used to predict the appropriate rate of return for an investment. Thus, a first range may be defined where the rate of return for an asset is below the appropriate rate of return, a second range is where the rate of return for the asset meets the appropriate rate of return, and a third range is where the rate of return for the asset is above the appropriate rate of return.

The ranges may then determine the display of a knowledge enhanced graphical symbol. In one embodiment, using the example above, a knowledge enhanced graphical symbol which represents an asset may display as red when the rate of return is below expectation, gray when the rate of return meets expectations, and black when the rate of return is above expectation.

In other embodiments, a predicted variable may be used to define a set of ranges reflecting more fine grained state transitions. For example, a set of ranges may be defined reflecting 51% or more below prediction, 50% to 5% below prediction, 4% below prediction to 4% above prediction, 5% to 50% above prediction, and 51% or more above prediction. In the example above, the five ranges then define five states of a metric reflected by knowledge enhanced graphical symbol on a graphical user interface.

In one embodiment, use of linear regression to automatically compute ranges for a variable may be implemented as a form of supervised learning where the end user selects a metric to be estimated and selects other predictive metrics which predict the value of the metric. The system then inputs the data representing values of predictive metrics and fits the data to a linear or polynomial equation using standard regression techniques. In one embodiment, linear equations are used as a default. In another embodiment, the user selects what form of model to use.

In another form of supervised learning, the user selects a metric to be estimated and the system selects various combinations of candidate predictor metrics, inputs the data representing values of the candidate predictive metrics, and fits the data to a linear or polynomial equation using standard regression techniques. In one embodiment, the system automatically selects the linear regression model that provides the closest fit to the data. In another embodiment, the user is displayed all linear regression models evaluates and is allowed to select one.

Nonlinear and Logistic Regression

Nonlinear regression extends linear regression to fit data to nonlinear functions of the form:

y=f(x1,x2, . . . ,a1,a2, . . . )

Such regression techniques are able model data which follows a pattern that does not exhibit linear behavior with respect to its parameters. The challenge presented by nonlinear regression is that a model must be selected or developed. Unfortunately developing a sophisticated non-linear model for complex data patterns often requires a deep understanding of the data or the system it represents. Nevertheless, there are a number of nonlinear functions that are generally useful to answer certain kinds of questions about a wide range of data.

Logistic regression is a variant of nonlinear regression that may be useful when the target (dependent) variable has only two possible values (e.g., live/die, buy/don't-buy, infected/not-infected). Logistic functions or logistic curve models the S-curve of growth of some set P. The initial stage of growth is approximately exponential; then, as saturation begins, the growth slows; and at maturity, growth stops.

As shown below, the unrestricted growth can be modeled as a rate term +rKP (a percentage of P). But as the population grows, some members of P (modeled as −rP2) interfere with each other in competition for some critical resource (which can be called the bottleneck, modeled by K). This competition slows the growth rate until the set P ceases to grow (maturity). It is represented in the formula:

$$P ( t ; a , m , n , τ ) = a \frac{1 + m {e}^{- t / τ}}{1 + n {e}^{- t / τ}}$$

for real parameters a, m, n, and τ. Logistic functions find applications in a range of fields, including biology and economics.

A sigmoid function is a special case of the logistic function with a=1, m=0, n=1, τ=1, namely

$$P ( t ) = \frac{1}{1 + {e}^{- t}} .$$

A sigmoid function derives its name from the shape of its graph since the function has the following special cases:

S(31 ∞)=0

S(+∞)=1

S(0)=½

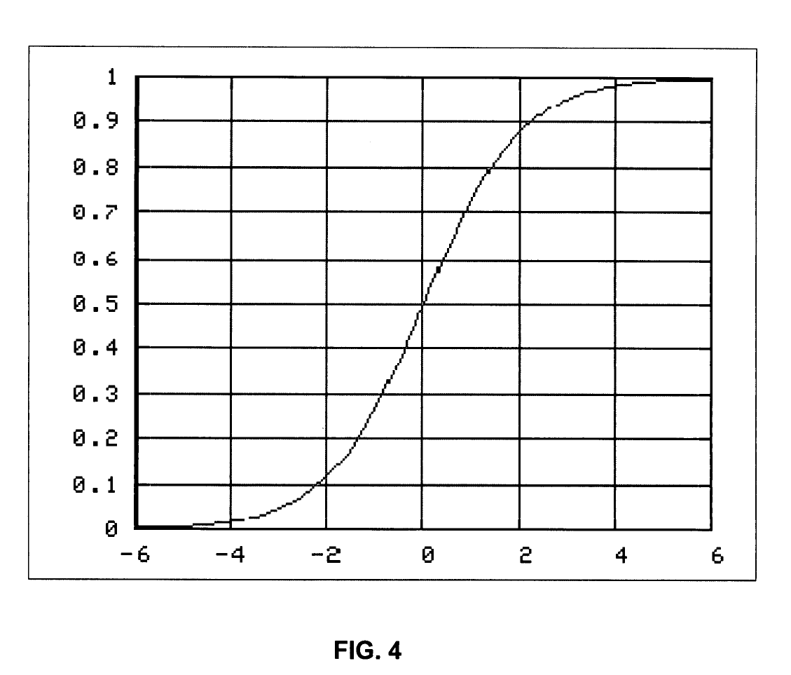

The sigmoid curve shows early exponential growth for negative t, which slows to linear growth of slope ¼ near t=0, then approaches y=1 with an exponentially decaying gap—which is what generates the sigmoid shape. One embodiment of a sigmoid curve is illustrated in FIG. 4. The sigmoid function is also called the standard logistic function and is often encountered in many technical domains, especially in artificial neural networks and statistics.

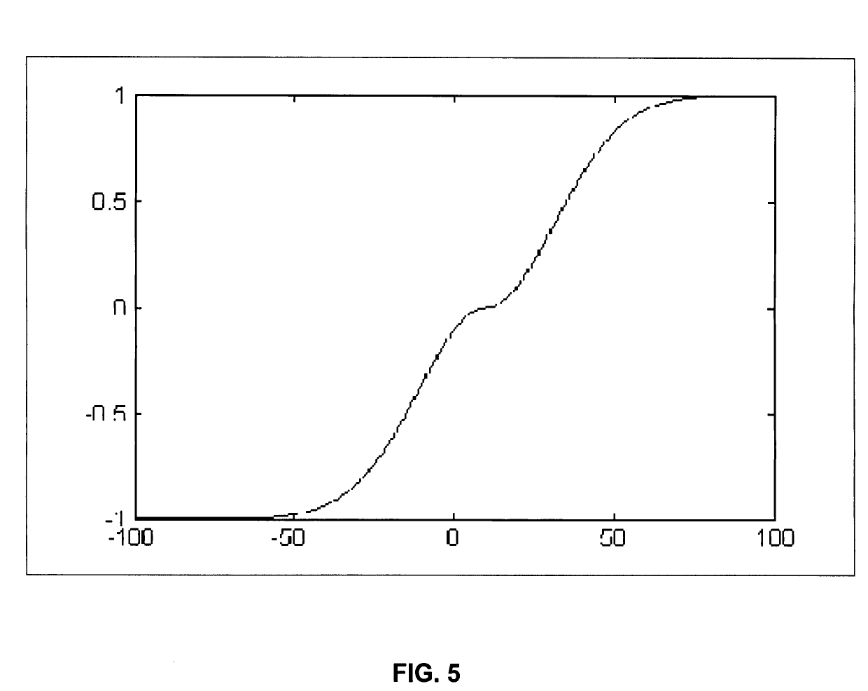

A double sigmoid function is a function similar to the sigmoid function with numerous applications. Its general formula is:

$$y = sign ( x - d ) ( 1 - exp ( - {( \frac{x - d}{s} )}^{2} ) ) ,$$

where d is its center and s is the steepness factor. One embodiment of a double sigmoid curve is illustrated in FIG. 5. The double sigmoid function is based on the Gaussian curve and graphically it is similar to two identical sigmoids bonded together at the point x=d. One of its applications is non-linear normalization of a data stream as it has the property of eliminating outliers—which helps limit out-of-paradigm conditions when the data is displayed.

Every logistic curve has a single inflection point that separates the curve into two equal regions of opposite concavity. The properties of logistic curves may be used to define ranges for a metric. In one embodiment, ranges are based on sigma deviations above or below the inflection point. For example, a normal state may be defined as ranging from one sigma below the inflection point to one sigma above the inflection point—a point where a majority of the data points should fall. Mildly above expectations would be from one sigma to two sigmas above the inflection point, and so on.

For example, a given metric such as sales for a specific location in a specific calendar month, may be fitted to a sigmoid or a double sigmoid curve. A range which may be considered normal may be range from one sigma below the inflection point to one sigma above the inflection point, a range that is below normal, from one sigma to two sigmas may be considered below normal, from two sigmas to three sigmas below the inflection point may be considered severely below normal, and so on. Thus, ranges may be associated with a range of sigmas or fractional sigmas above or below the inflection point of a sigmoid or double sigmoid curve.

The ranges may then determine the display of a knowledge enhanced graphical symbol. In one embodiment, using the example above, a knowledge enhanced graphical symbol which represents sales may display as light red when the sales are below the inflection point, but less that one sigmoid below the inflection point, dark red when the sales are more than one sigmoid below the inflection point of the curve, gray when sales are above the inflection point, but less than one sigmoid above the inflection point, and black when sales are more than one sigmoid above the inflection point. The number of ranges so defined may be automatically determined, or may be a user configurable parameter.

The steepness factor s can be adjusted and provides essentially a contrast control for the display. Changing s results in the sharpening or flatting of the curve in the mid ranges. Thus, changing the s values to flatten the curve would result in a display with less data points above or below expectations. The steepness factor s could be associated with a specific knowledge enhance graphical symbol, but could also be associated with a user—allowing some users to view one or more view specific knowledge enhanced graphical symbol with more sensitive ranges than other users. This, for example, would allow lower level managers to view knowledge enhance graphical symbol with more sensitive ranges than higher-level managers, so problems can be addressed earlier.

Those skilled in the art will realize that besides the logistic function, sigmoid functions include the ordinary arc-tangent, the hyperbolic tangent, and the error function, as well as algebraic functions like

$$f ( x ) = \frac{x}{\sqrt{1 + {x}^{2}}}$$

The integral of any smooth, positive, “bump-shaped” function will be sigmoidal, thus the cumulative distribution functions for many common probability distributions are sigmoidal, and can therefore be utilized by embodiments of the disclosed system and method to define ranges based on sigma deviations, or fractions thereof, of a input metric.

In one embodiment, use of nonlinear regression based on a sigmoid curve model to automatically compute ranges for a variable may be implemented as a form of supervised learning where the end user selects a metric to be analyzed. The system then inputs the data representing values of the metric and fits the data to a sigmoidal function using standard regression techniques. In one embodiment, a default sigmoidal function is used. In another embodiment, the user is allowed to select one or more sigmoidal function to be evaluated. In yet another embodiment, the system fits multiple sigmoidal functions to the data, displays the results of the analysis, and allows the user to select a model for use in determining state ranges.

K-Means Algorithm

The k-means algorithm is an algorithm which may be used to parturition n objects based on attributes into k partitions, where k<n. Such partitions may be used to represent states in a metric that may assume multiple states. In one embodiment, data for a given metric may be input and clustered appropriately into partitions using an embodiment of k-means analysis to determine the centroids of each partition.

In one embodiment, an iterative refinement heuristic known as the Lloyd's algorithm (also known as Voronoi iteration), is used. Lloyd's algorithm is used by the system to partition input heuristic data into a defined number of partitions. The number of partitions may be defined by default, or may be specified by the user for a desired number of states represented by a knowledge enhance graphical symbol. The mean point, or centroid of each partition is calculated. New partitions are then constructed by associating each input point with the closest centroid. These centroids then are recalculated for the new partitions and the process is repeated until convergence, which is obtained when the points no longer switch sets or the centroids are no longer changed. Those skilled in the art will realize that other forms of clustering algorithms (such as the expectation-maximization algorithm for mixtures of Gaussians) can be adapted to accomplish this task as well, but with different performance characteristics.

The centroids thus computed may be used to define ranges for a metric. In one embodiment, one range is defined for every centroid such that a centroid is the midpoint of the range, and the range surrounding the centroid is defined as a lower and upper bound such that the bound between two centroids is the mid point between the two centroids. For example, for a metric whose values span 0 to 10, if centroids of 2.0, 6.0, and 9.0 are identified, then three ranges may be defined, 0.0-4.0, 4.1-7.5, and 7.6-10.0.

The ranges may then determine the display of a knowledge enhanced graphical symbol. In one embodiment, using the example above, a knowledge enhanced graphical symbol which represents metric may display as red when the value of the metric falls in the first range, gray when the value of the metric falls in the second range, and black when the value of the metric falls in the third range.

In one embodiment, use of k-means algorithm to automatically compute ranges for a variable may be implemented as a form of supervised learning where the end user selects a metric and selects a number of states to compute, n. The system then inputs the data representing values of metrics and fits to n ranges using any form of k-means analysis techniques.

In one embodiment, use of k-means algorithm to automatically compute ranges for a variable may be implemented as a form of unsupervised learning where data containing multiple metrics is input to the system and multiple clustering algorithms are applied to every metric. For every metric, the “rightness” of each applied algorithm is evaluated, and the utilize the algorithm which provides the best fit to the data is utilized.

Aggregation and Business Logic

In many environments, for example, many business environments, metrics are strongly affected by external factors. For example such external factors may include time of day, day of week, weekend information, specific external functions such as sales/marketing campaigns, scheduled work shutdowns, power outages, and the like. Thus, aggregating data without taking such external factors into account may lead to erroneous results.

Aggregation can be properly handled within embodiments of the system by adding more complex algorithms based on time or other factors (available to the system). Additional models can be utilized within the system for aggregation and business modeling depending on organizational goals and objectives for developing data mining and learning methodologies, provided sufficient data is provided to the system to attain degree an appropriate level of confidence. For examples, embodiments of the system may integrate logistic functions with built-in adaptive algorithms that change the logistic function's modeling statistics based on external or internal information that flows through the data stream.

Change Management

Another implication of a statistically backed metrics is change management. Today's valid measurement may not be relevant tomorrow. Businesses must adapt: and adaptation will affect the assumptions upon which the business operates. Even when a metric measurement is restricted to internal systems, change in one area will have a ripple effect throughout the enterprise. Effects can be felt indirectly, via the metric's output to downstream processes; or they can be felt directly when the results serve as a key component in a system of metrics.

Utilizing an automated process for statistical determination of ranges for metrics, ranges for any or all metrics may be updated on demand or periodically, or on a scheduled basis to insure continuous review and maintenance of metrics determiners, and a statistical relevance that the indicators are true and accurate. With a real statistical basis driving the ranges, events within an organization are better managed in ways that prevent intervention to a monitored process by wrongly reacting to events that are not statistically meaningful.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

We claim:

1. A method comprising the steps of:
selecting at least one metric to analyze, wherein the metric relates to at least one property of an object within a problem set;
specifying range parameters to be used in generating state ranges for each selected metric, wherein the range parameters comprise the number of state ranges to be generated for each metric and at least one statistical model to be used in creating the state ranges;
inputting data reflecting the values of each selected metric and values of any other metrics which are necessary to perform the requested statistical analysis, wherein the data is input from at least one data source;
analyzing the input data for each selected of the selected metrics using the range parameters, wherein the results of the analysis comprise at least one state range for each of the selected metrics and each of the selected statistical models;
selecting one of the at least one statistical models for each of the selected metrics, wherein the selected statistical model provides the best fit to the data
outputting the at least one state range for each of the selected metrics and selected statistical models, wherein the at least one state ranges are used by a display medium to display data for at least one of the selected metrics as a graphical representation of a state of an object to which the metric relates;
wherein each of the steps in the method are performed by at least one computer

2. The method of claim 1 wherein at least one property of the at least one statistical model is modified by a user using a graphical user interface, at least one configuration file, at least one shared communication table, or an API called from an external system.

3. The method of claim 2 wherein the graphical user interface displays a plurality of a states, and allows the modification of weighting factors for each of the plurality of states, or allows entry or multiple weighting factors that determine how grouping or heuristics are computed.

4. The method of claim 1 wherein the at least one metric is selected by a user using a graphical user interface.

5. The method of claim 1 wherein the at least one metric is selected automatically using selection criteria supplied by a system operating on a server.

6. The method of claim 1 wherein the range parameters are specified by a user using a graphical user interface.

7. The method of claim 1 wherein the range parameters are specified automatically by a system operating on a server.

8. The method of claim 1 wherein the data source is a computer readable medium.

9. The method of claim 1 wherein the data source is a server.

10. The method of claim 1 wherein the statistical model providing the best fit to the data is selected by a user using a graphical user interface.

11. The method of claim 1 wherein the statistical model providing the best fit to the data is selected by a system operating on a server.

12. The method of claim 1 wherein the at least one state range for each of the selected metrics and selected statistical models is output to a computer readable medium.

13. The method of claim 1 wherein the display medium is a graphical user interface which displays the data for at least one of the selected metrics using knowledge enhanced graphical symbols.

14. A computer-readable medium having computer-executable instructions for a method comprising the steps of:
selecting at least one metric to analyze, wherein the metric relates to at least one property of an object within a problem set;
specifying range parameters to be used in generating state ranges for each selected metric, wherein the range parameters comprise the number of state ranges to be generated for each metric and at least one statistical model to be used in creating the state ranges;
inputting data reflecting the values of each selected metric and values of any other metrics which are necessary to perform the requested statistical analysis, wherein the data is input from at least one data source;
analyzing the input data for each selected of the selected metrics using the range parameters, wherein the results of the analysis comprise at least one state range for each of the selected metrics and each of the selected statistical models;
selecting one of the at least one statistical models for each of the selected metrics, wherein the selected statistical model provides the best fit to the data; and,
outputting the at least one state range for each of the selected metrics and selected statistical models, wherein the at least one state ranges are used by a display medium to display data for at least one of the selected metrics as a graphical representation of a state of an object to which the metric relates.
wherein each of the steps in the method are performed by at least one computer.

15. The computer readable medium of claim 14 wherein at least one property of the at least one statistical model is modified by a user using a graphical user interface, at least one configuration file, at least one shared communication table, or an API called from an external system.

16. The computer readable medium of claim 15 wherein the graphical user interface displays a plurality of a states, and allows the modification of weighting factors for each of the plurality of states, or allows entry or multiple weighting factors that determine how grouping or heuristics are computed.

17. The computer readable medium of claim 14 wherein the at least one metric is selected by a user using a graphical user interface.

18. The computer readable medium of claim 14 wherein the at least one metric is selected automatically using selection criteria supplied by a system operating on a server.

19. The computer readable medium of claim 14 wherein the range parameters are specified by a user using a graphical user interface.

20. The computer readable medium of claim 14 wherein the range parameters are specified automatically by a system operating on a server.

21. The computer readable medium of claim 14 wherein the data source is a computer readable medium.

22. The computer readable medium of claim 14 wherein the data source is a server.

23. The computer readable medium of claim 14 wherein the statistical model providing the best fit to the data is selected by a user using a graphical user interface.

24. The computer readable medium of claim 14 wherein the statistical model providing the best fit to the data is selected by a system operating on a server.

25. The computer readable medium of claim 14 wherein the at least one state range for each of the selected metrics and selected statistical models is output to a computer readable medium.

26. The computer readable medium of claim 14 wherein the display medium is a graphical user interface which displays the data for at least one of the selected metrics using knowledge enhanced graphical symbols.

27. A system comprising:
an automatic range determination server comprising:
a metric selection module that selects at least one metric to analyze, wherein the metric relates to at least one property of an object within a problem set;
a range specification module that specifies range parameters to be used in generating state ranges for each selected metric, wherein the range parameters comprise the number of state ranges to be generated for each metric and at least one statistical model to be used in creating the state ranges;
a metric data input module which inputs data reflecting the values of each selected metric and values of any other metrics which are necessary to perform the requested statistical analysis, wherein the data is input from at least one data source;
a statistical analysis module that analyzes the input data for each of the selected metrics using the range parameters, wherein the results of the analysis comprise at least one state range for each of the selected metrics and each of the selected statistical models;
a best fit selection module that selects one of the at least one statistical models for each of the selected metrics, wherein the selected statistical model provides the best fit to the data;
a range data output module that outputs the at least one state range for each of the selected metrics and selected statistical models, wherein the at least one state ranges are used by a display medium to display data for at least one of the selected metrics as a graphical representation of a state of an object to which the metric relates.

28. The system of claim 27 wherein the range specification module enables an end user to modify at least one property of the at least one statistical model using a graphical user interface, at least one configuration file, at least one shared communication table, or an API called from an external system.

29. The system of claim 28 wherein the graphical user interface displays a plurality of a states, and allows the modification of weighting factors for each of the plurality of states, or allows entry or multiple weighting factors that determine how grouping or heuristics are computed.

30. The system of claim 27 wherein the metric selection module enables an end user to select the at least one metric using a graphical user interface.

31. The system of claim 27 wherein the at least one metric is selected automatically by the metric selection module using selection criteria supplied by a system operating on a server.

32. The system of claim 27 wherein the range specification module enables an end user to select the range parameters using a graphical user interface.

33. The system of claim 27 wherein the range parameters are specified automatically by a system operating on a server.

34. The system of claim 27 wherein the data source from which the metric data input module inputs data is a computer readable medium.

35. The system of claim 27 wherein the data source from which the metric data input module inputs data is a server.

36. The system of claim 27 wherein the best fit selection module enables an end user to select the statistical model providing the best fit to the data using a graphical user interface.

37. The system of claim 27 wherein the best fit selection module enables a system operating on a server to select the statistical model providing the best fit to the data.

38. The method of claim 27 wherein the range data output module outputs the at least one state range for each of the selected metrics and selected statistical models to a computer readable medium.

39. The method of claim 27 wherein the display medium is a graphical user interface which displays the data for at least one of the selected metrics using knowledge enhanced graphical symbols.
